(19) United States
(12) Patent Application Publication
(10) Pub. No.: US 2012/0118515 A1
(43) Pub. Date: May 17, 2012

(54) LIFT CORD ASSEMBLY FOR VENETIAN BLIND

(76) Inventor: Chin-Fu CHEN, Taichung (TW)

(21) Appl. No.: 12/947,967

(22) Filed: Nov. 17, 2010

(51) Int. Cl. E06B 9/303

(52) U.S. Cl. 160/170

(57) ABSTRACT

A lift cord assembly for a Venetian blind includes a first rotating member for connection of two ladder strings, and a second rotating member rotated synchronously with the first rotating member for connection of a single lift cord. By this design, the first rotating member and the second rotating member can be forced to rotate synchronously by the actuation of the lift cord, enabling the ladder strings to be wound around the first rotating member to fold slats of the Venetian blind. As a result, the ladder strings can be integrated by the lift cord assembly of the present invention into the lift cord so as to attain the purposing of enhancing safety of children in the household.

### BACKGROUND OF THE INVENTION

1. Field of the Invention

The present invention relates generally to a Venetian blind, and more specifically to a lift cord assembly for a Venetian blind, which can protect safety of children in the household.

2. Description of the Related Art

FIG. 1 shows a conventional Venetian blind 10, comprising an upper rail 11, a lower rail 12, a plurality of slats 13 arranged between the upper rail 11 and the lower rail 12, and two ladder strings 14 passing through the slats 13 and having a bottom end connected with the lower rail 12 and a top end suspended from the upper rail 11 through a stopper 15 mounted in the upper rail 11. Therefore, when the suspending portions 142 of the ladder strings 14 are pulled simultaneously, the lower rail 12 can be gradually raised to fold the slats 13.

According to different needs, the slat 13 will be designed to increase its width such that the number of the ladder strings 14 has to be added in order to enable the widened slats 13 to be folded and unfolded smoothly and balancedly. However, if the ladder strings 14 are too numerous, the ladder strings 14 will have too many suspending portions 142, causing children playing around the conventional Venetian blind 10 to be easily get caught by them. Thus, the conventional Venetian blind 10 has a potential danger to children in the household.

### SUMMARY OF THE INVENTION

It is one objective of the present invention to provide a lift cord assembly for a Venetian blind, which can prevent children from getting caught therein to protect the safety of the household.

To achieve this objective of the present invention, the lift cord assembly provided by the present invention comprises a base for being mounted in an upper rail of the Venetian blind, a first rotating member rotatably mounted with the base for connection of top ends of ladder strings of the Venetian blind, a second rotating member rotatably mounted with the base and synchronously rotated with the first rotating member, and a lift cord having one end connected with the second rotating member and the other end for being suspended from the upper rail. When a user pulls a suspending portion of the lift cord, the second rotating member is driven to rotate, and then the first rotating member is rotated synchronously through the rotation of the second rotating member. Thus, the ladder strings can be wound around the first rotating member through the rotation of the first rotating member to fold slats of the Venetian blind.

By the aforesaid design, no matter how many ladder strings are provided, the ladder strings can be integrated by the lift cord assembly of the present invention into one single lift cord so as to prevent children from getting caught by the lift cord and therefore enhance the safety of the household.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus are not limitative of the present invention, and wherein:

FIG. 1 is a plan view of a Venetian blind according to a prior art;

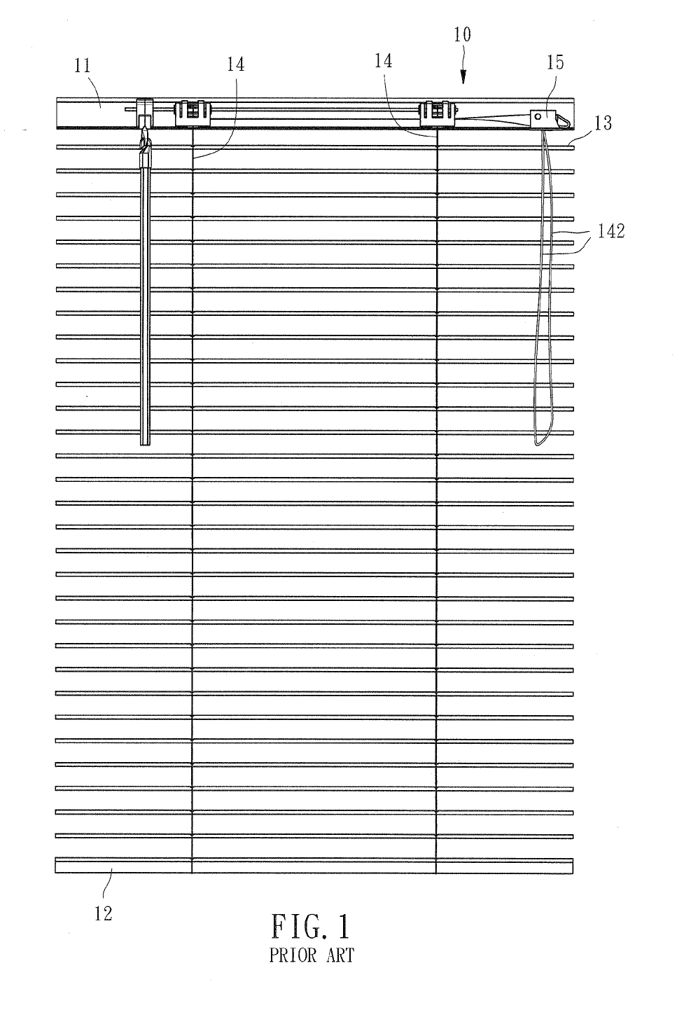

FIG. 2 is a perspective view of a Venetian blind in which a lift cord assembly according to a first embodiment of the prevent invention is installed;

FIG. 3 is an exploded view of the lift cord assembly according to the first embodiment of the prevent invention, in which the lift cord is removed for concise illustration purpose;

FIG. 4 is a top view of FIG. 2;

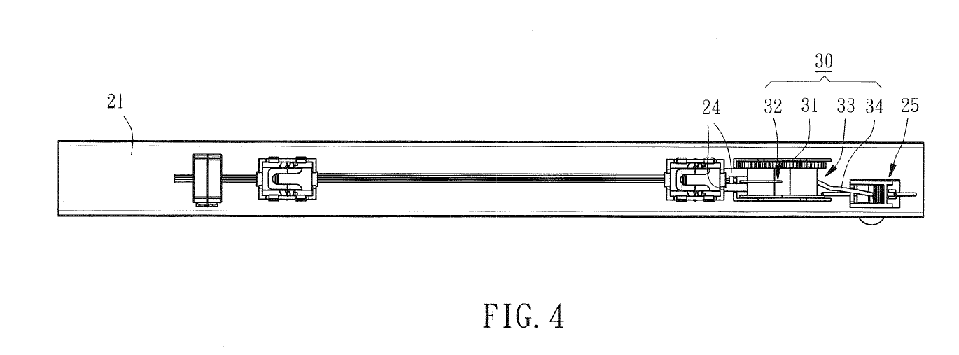

FIG. 5 is a plan view of a part of the Venetian blind, showing the slats are unfolded;

FIG. 6 is similar to FIG. 5, but showing the slats are folded;

FIG. 7 is an exploded view of the lift cord assembly according to a second embodiment of the prevent invention, in which the lift cord is removed for concise illustration purpose;

FIG. 8 is a top view of a Venetian blind equipped with the lift cord assembly according to the second embodiment of the prevent invention;

FIG. 9 is an enlarged view of FIG. 8, showing the lift cord assembly according to the second embodiment of the prevent invention;

FIG. 10 is a plan view of a part of the Venetian blind equipped with the lift cord assembly of the second embodiment, showing the slats are unfolded;

FIG. 11 is similar to FIG. 10, but showing the slats are folded;

FIG. 12 is an exploded view of the lift cord assembly according to a third embodiment of the prevent invention, in which the lift cord is removed for concise illustration purpose;

FIG. 13 is a top view of a Venetian blind equipped with the lift cord assembly according to the third embodiment of the prevent invention;

FIG. 14 is an enlarged view of FIG. 13, showing the lift cord assembly according to the third embodiment of the prevent invention;

FIG. 15 is a plan view of a part of the Venetian blind equipped with the lift cord assembly of the third embodiment, showing the slats are unfolded; and

FIG. 16 is similar to FIG. 15, but showing the slats are folded.

### DETAILED DESCRIPTION OF THE INVENTION

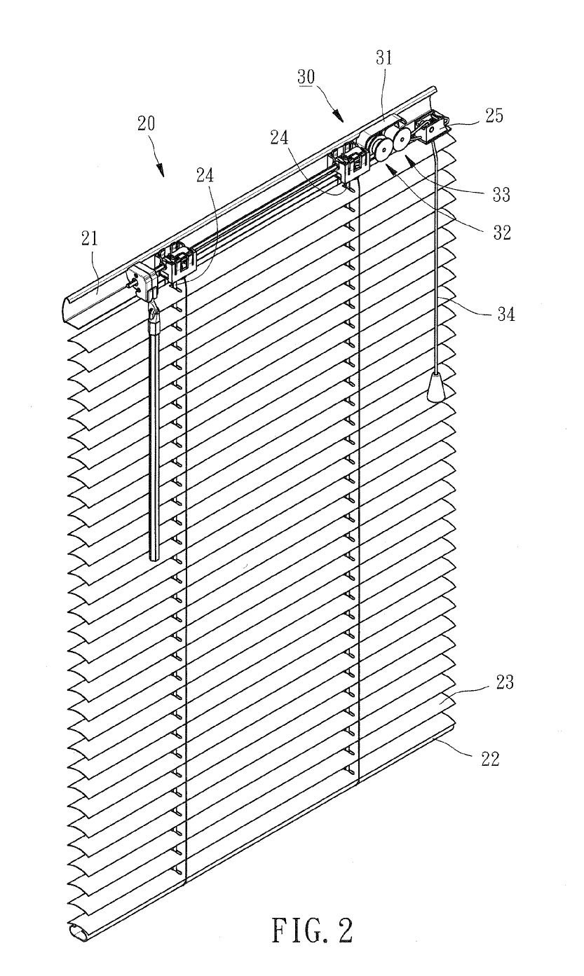

As shown in FIG. 2, a lift cord assembly 30 in accordance with a first embodiment of the present invention is installed in a Venetian blind 20. In this embodiment, the Venetian blind 20 includes an upper rail 21, a lower rail 22, a plurality of slats 23 arranged between the upper rail 21 and the lower rail 22, and two ladder strings 24 each passing through the slats 23, having a bottom end connected with the lower rail 22 and a top end received in the upper rail 21, and having a rectangular cross-section. The lift cord assembly 30 according to the first embodiment of the present invention comprises a base 31, a first rotating member 32, a second rotating member 33, and a lift cord 34.

The base 31 is a hollow and rectangular box, and mounted in the upper rail 21 of the Venetian blind 20.

The first rotating member 32 is rotatably connected between two opposite sides of the base 31, having a first rod 322 for connection of the top ends of the ladder strings 24, a first spur gear 324 connected with one end of the first rod 322, and two first wheels 326 and 328, one of which is connected with the other end of the first rod 322, and the other of which is connected with a middle of the first rod 322 to divide the ladder strings 24 from each other.

The second rotating member 33 is rotatably connected between two opposite sides of the base 31, having a second rod 332 parallel to the first rod 322, a second wheel 334 connected with one end of the second rod 332, and a second spur gear 336 connected with the other end of the second rod 332 and engaged with the first spur gear 324.

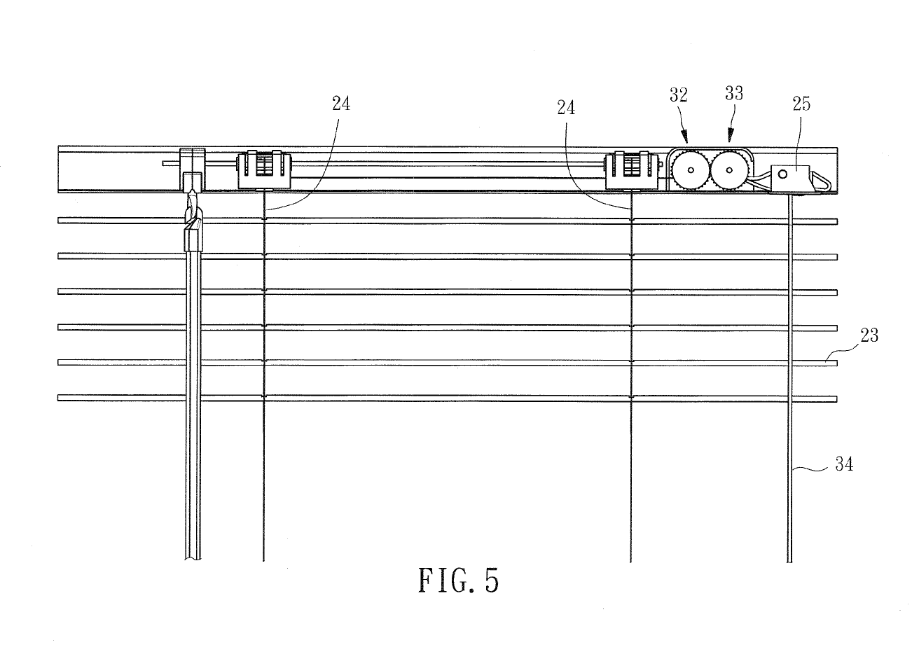

The lift cord 34 has a circular cross-section, and has one end connected with the second rod 332 of the second rotating member 33, and the other end suspending from the upper rail 21 through a stopper 25 mounted in the upper rail 21, as shown in FIG. 5.

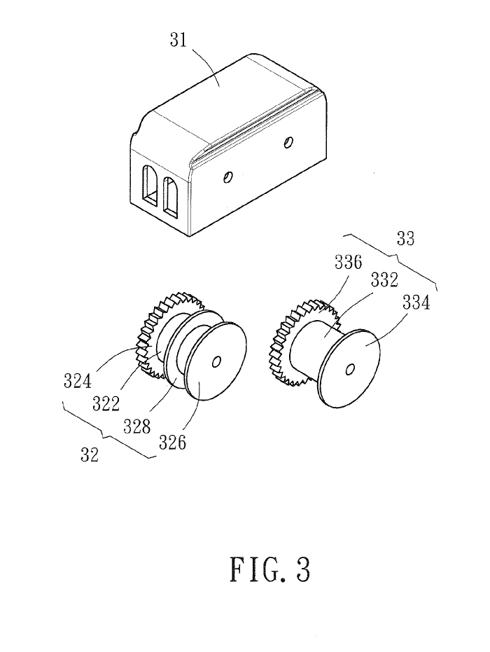

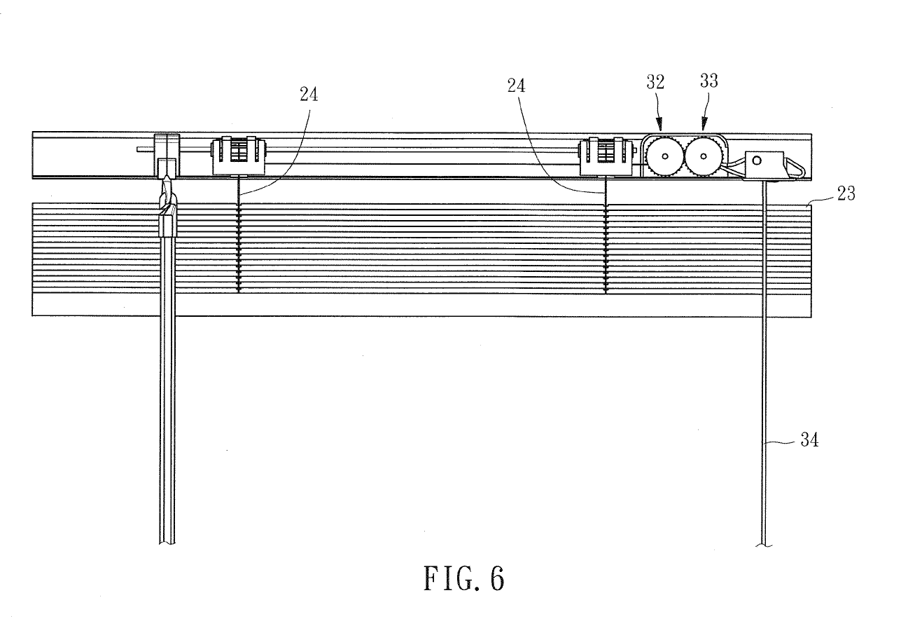

When the suspending portion of the lift cord 34 is pulled by an external force, as shown in FIGS. 3 and 6, the second rotating member 33 is driven to rotate by the lift cord 34, and then the first rotating member 32 is rotated synchronously by the second rotating member 33 through the engagement between the second spur gear 336 and the first spur gear 324. During the rotation of the first rotating member 32, the ladder strings 24 can be wound around the first rod 322 of the first rotating member 32 to gradually fold the slats 23.

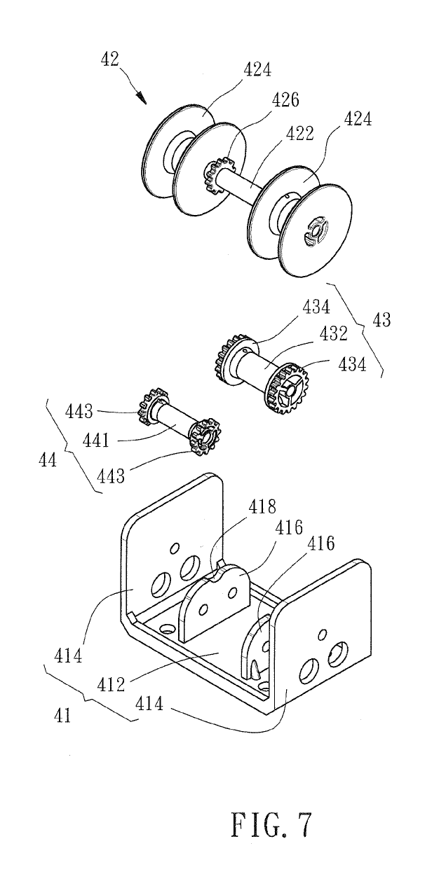

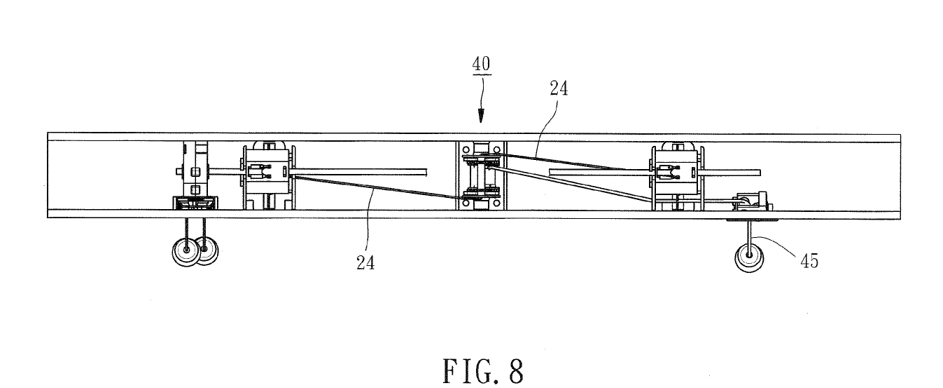

FIGS. 7 to 9 show a lift cord assembly 40 in accordance with a second embodiment of the present invention, comprising a base 41, a first rotating member 42, a second rotating member 43, a third rotating member 44, and a lift cord 45.

The base 41 includes two opposite lateral plates 414, a bottom plate 412 connected between the lateral plates 414, two support portions 416 protruding from a top surface of the bottom plate 412 and each having a concavity 418 at a top end thereof.

The first rotating member 42 includes a first rod 422 rotatably placed on the concavities 418 of the support portions 416 of the base 41, two first reels 424 respectively connected with two ends of the first rod 422 for connection of the top ends of the ladder strings 24, and two spur gear 426 respectively connected with the first rod 422 at locations near two ends of the first rod 422 and spaced a distance from the adjacent first reel 424.

The second rotating member 43 is rotatably connected between the support portions 416 of the base 41, having a second rod 432 for connection of the lift cord 45 and two second spur gears 434 respectively connected with two ends of the second rod 432 and engaged with the adjacent first spur gear 426.

The third rotating member 44 is rotatably connected between the support portions 416 of the base 41, having a third rod 441 and two third spur gears 443 respectively connected with two ends of the third rod 441 and engaged with the adjacent first spur gear 426 and the adjacent second spur gear 434.

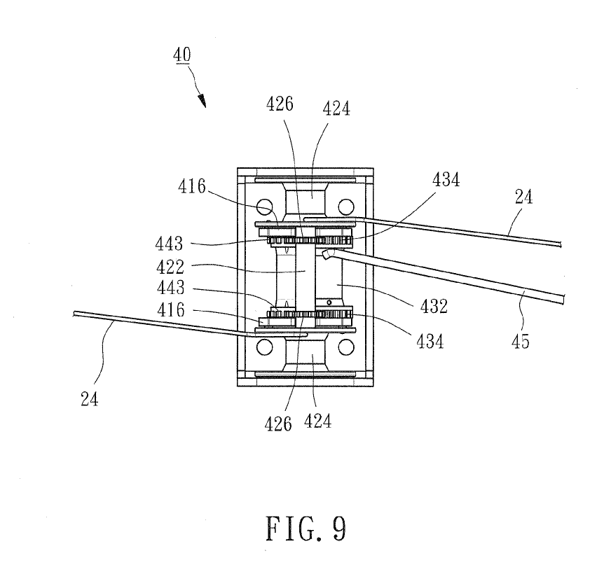

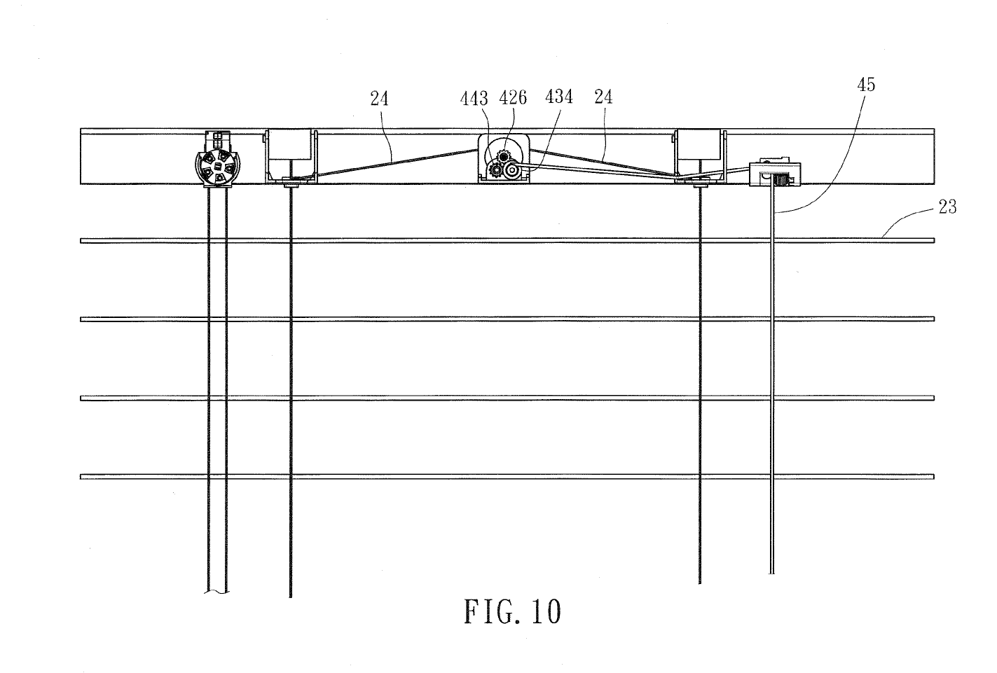

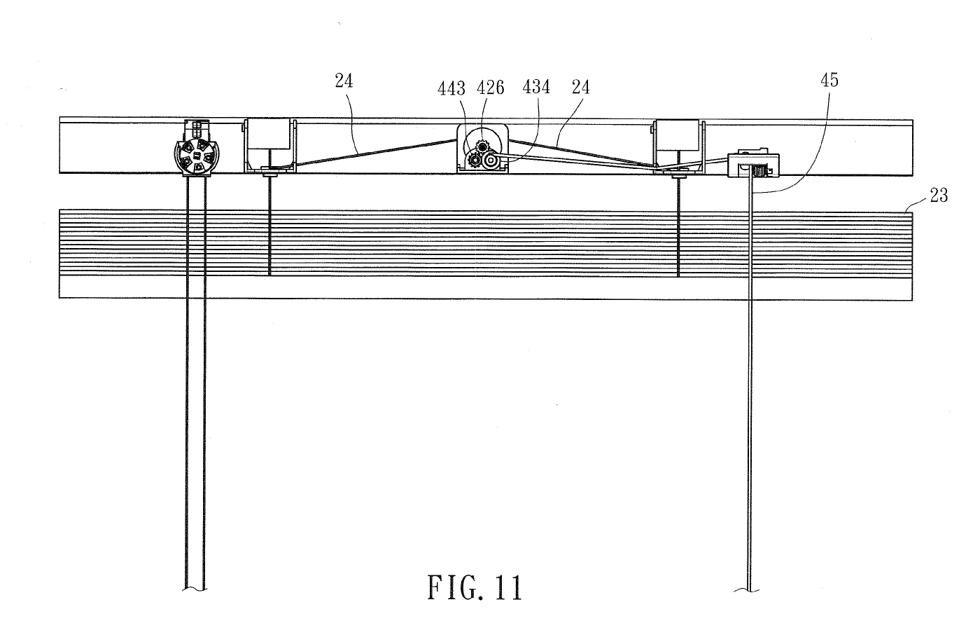

By this way, when the suspending portion of the lift cord 45 is pulled by the external force, as shown in FIGS. 9 to 11, the second rotating member 43 is driven to rotate by the lift cord 45, and then the first rotating member 42 is rotated synchronously by the second rotating member 43 through the engagement between the second spur gears 434 and the first spur gears 426, and meanwhile the third rotating member 44 is rotated synchronously through the engagement among the second spur gears 434, the first spur gears 426, and the third spur gears 443. Thereafter, the ladder strings 24 can be wound around the first reels 424 of the first rotating member 42 during the rotation of the first rotating member 42 to gradually fold the slats 23.

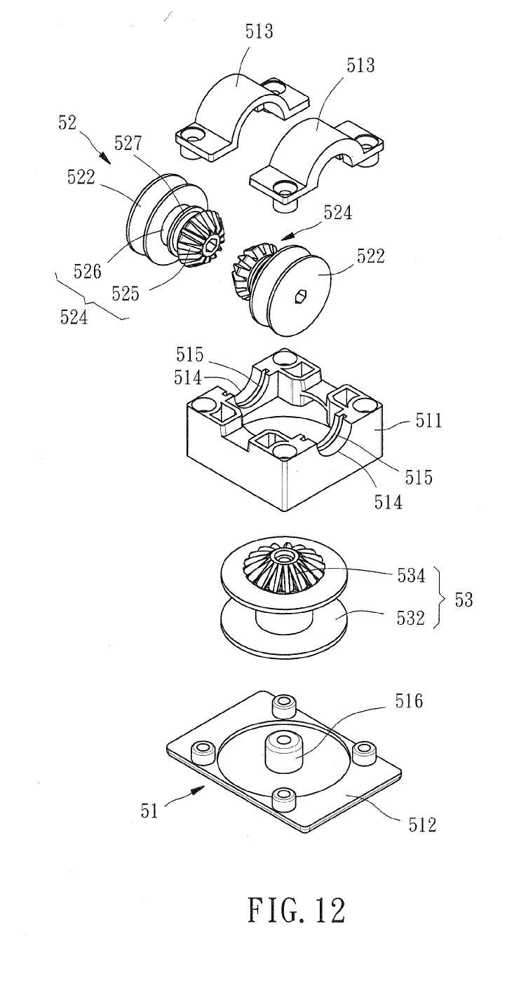

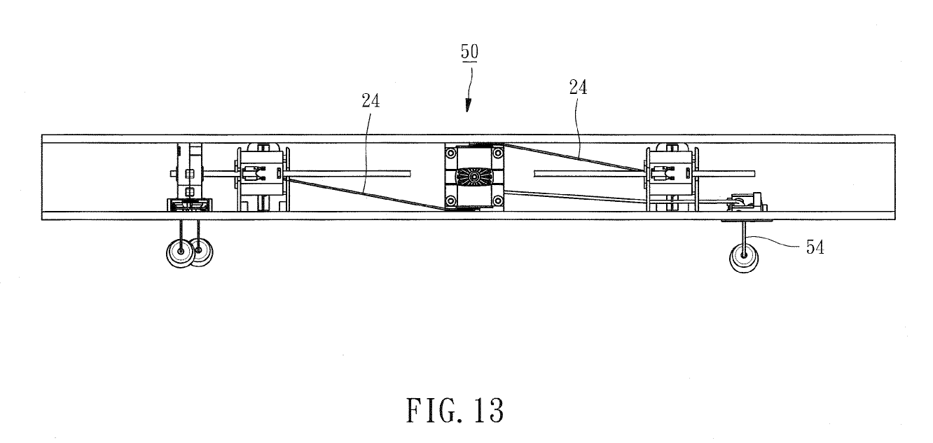

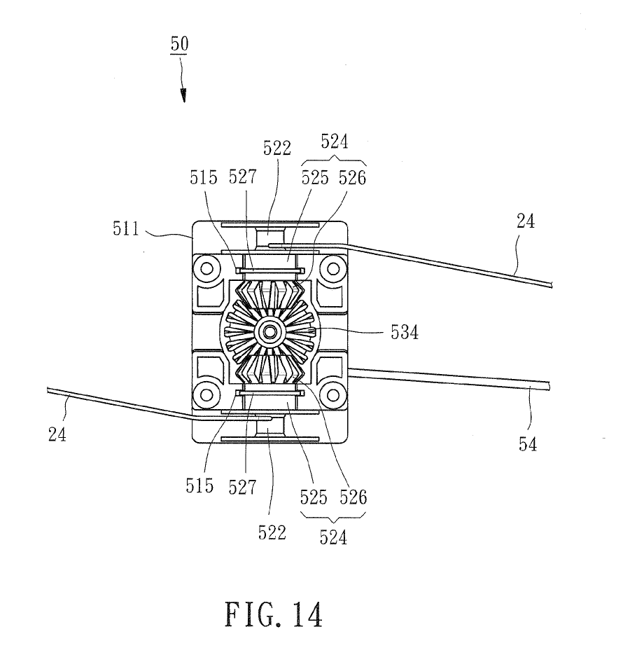

FIGS. 12 to 14 show a lift cord assembly 50 in accordance with a third embodiment of the present invention, comprising a base 51, a first rotating member 52, a second rotating member 53, and a lift cord 54.

The base 51 includes an upper base body 511 having two opposite curved notches 514 at a top surface thereof and two slots 515 each formed at a periphery of one of the curved notches 514, a lower base body 512 fastened to a bottom side of the upper base body 511 and provided with a post 516 protruding from a top surface thereof, and two covers 513 spacedly fastened to a top side of the upper base body 511.

The first rotating member 52 includes two first reels 522 for connection of the top ends of the ladder strings 24, and two first bevel gears 524 each having a teeth portion 525 and a shaft portion 526 connected between the teeth portion 525 and the first reel 522 and provided with a protrusion 527 at an outer periphery thereof inserted into one of the slots 515 of the upper base body 511, such that the two first bevel gear 524 of the first rotating member 52 are rotatably and oppositely mounted on the top side of the upper base body 511 and covered by the covers 513.

The second rotating member 53 includes a second reel 532 having a bottom side inserted by the post 516 of the lower base body 512 and connected with one end of the lift cord 54 such that the second reel 532 can be pulled to rotate by the lift cord 54, and a second bevel gear 534 connected with a top side of the second reel 532 and engaged with the first bevel gears 524 such that the first rotating member 52 can be driven to rotate through the rotation of the second reel 532.

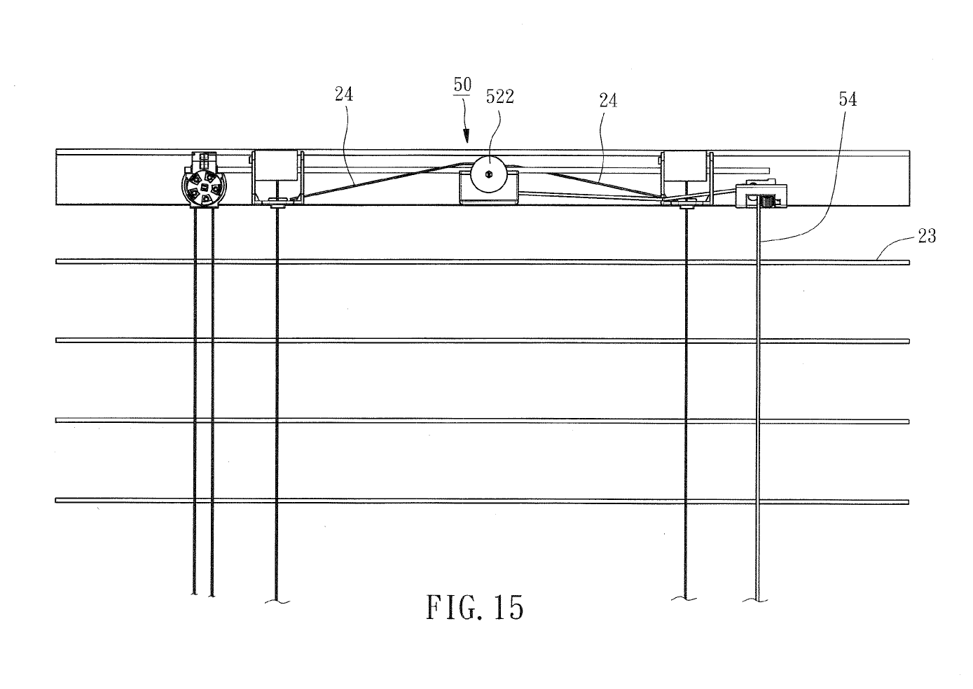

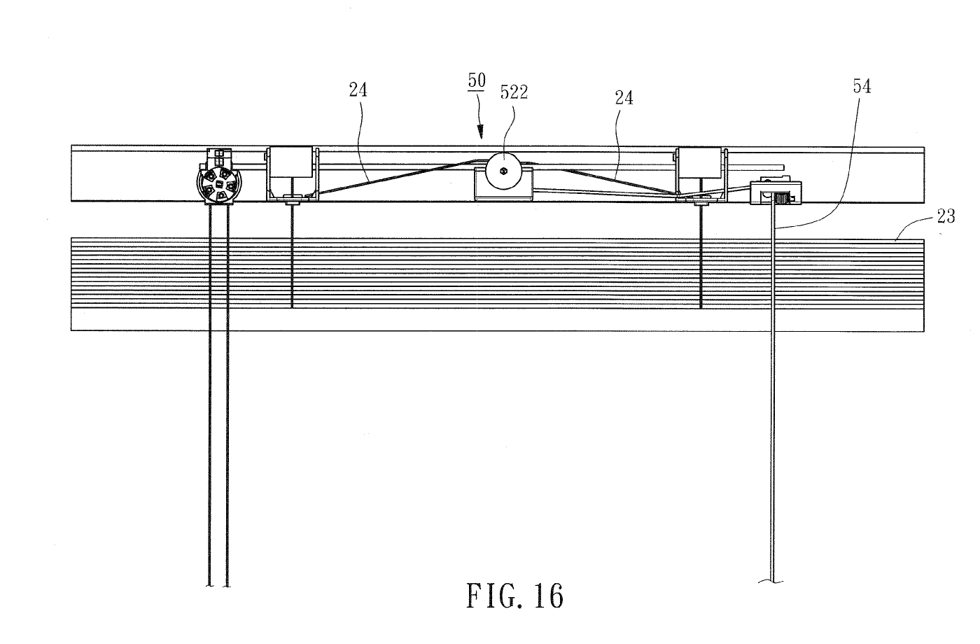

When the suspending portion of the lift cord 54 is pulled by the external force, as shown in FIGS. 12, and 14 to 16, the second rotating member 53 is driven to rotate by the lift cord 54, and then the first reels 522 are driven to rotate synchronously by the second rotating member 43 through the engagement between the second bevel gear 534 and the first bevel gears 524, and meanwhile the ladder strings 24 can be wound around the first reels 522 of the first rotating member 52 during the rotation of the first reels 522 so as to gradually fold the slats 23.

Accordingly, even though the number of the ladder string is added in order to cooperate with the widened slat, the lift cord assembly of the present invention can be used to integrate all of the ladder strings into one suspending lift cord for preventing children from getting caught by the lift cord and enhancing the safety of the household.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A lift cord assembly for a Venetian blind having an upper rail, a lower rail, a plurality of slats arranged between the upper rail and the lower rail, and two ladder strings each passing through the slats and having a bottom end connected with the lower rail and a top end received in the upper rail, the lift cord assembly comprising:
a base for being mounted in the upper rail;
a first rotating member rotatably mounted with the base for connection of the top ends of the ladder strings;
a second rotating member rotatably mounted with the base and synchronously rotated with the first rotating member; and
a lift cord having one end connected with the second rotating member and the other end for being suspended from the upper rail.

2. The lift cord assembly as claimed in claim 1, wherein the first rotating member includes a first rod for connection of the top ends of the ladder strings, a first spur gear connected with one end of the first rod, and two first wheels, one of which is connected with the other end of the first rod, and the other of which is connected with a middle of the first rod to divide the ladder strings from each other; the second rotating member includes a second rod for connection of the lift cord, a second wheel connected with one end of the second rod, and a second spur gear connected with the other end of the second rod and engaged with the first spur gear.

3. The lift cord assembly as claimed in claim 1, wherein the first rotating member includes a first rod, two first reels respectively connected with two ends of the first rod for connection of the top ends of the ladder strings, and two first spur gears respectively connected with the first rod at locations near two ends of the first rod to be spaced a distance from the adjacent first reel; the second rotating member includes a second rod for connection of the lift cord, and two second spur gears respectively connected with two ends of the second rod and engaged with one of the first spur gears.

4. The lift cord assembly as claimed in claim 3, wherein the base includes two opposite lateral plates, a bottom plate connected between the lateral plates, and two support portions protruding from a top surface of the bottom plate for supporting the first rod of the first rotating member and connecting with the second rotating member.

5. The lift cord assembly as claimed in claim 4, further comprising a third rotating member rotatably connected between the support portions of the base, and provided with a third rod and two third spur gears respectively connected with two ends of the third rod and engaged with one of the first spur gears and one of the second spur gears.

6. The lift cord assembly as claimed in claim 1, wherein the first rotating member includes two first reels for connection of the top ends of the ladder strings, and two first bevel gears each connected with one side of one of the first reels; the second rotating member includes a second reel for connection of the lift cord, and a second bevel gear connected with a top surface of the second reel and engaged with the first bevel gears.

7. The lift cord assembly as claimed in claim 6, wherein the base includes an upper base body having two slots at a top surface thereof, and a lower base body fastened to the upper base body and having a post protruding from a top surface thereof and inserting into the second reel; the first bevel gears each have a teeth portion and a shaft portion connected between the teeth portion and the first reel, and having a protrusion at an outer surface thereof inserted into one of the slots of the upper base body.

8. The lift cord assembly as claimed in claim 7, wherein the base has two covers fastened to the top surface of the upper base body and covering the first rotating member.

9. The lift cord assembly as claimed in claim 1, wherein the ladder strings each have a rectangular cross-section.

10. The lift cord assembly as claimed in claim 1, wherein the lift cord has a circular cross-section.
